(19) United States
(12) Patent Application Publication
(10) Pub. No.: US 2015/0013871 A1
(43) Pub. Date: Jan. 15, 2015

(54) Compression Molded Green Rubber Component and Method for Manufacturing the Same

(71) Applicant: Bridgestone Americas Tire Operations, LLC, Nashville, TN (US)

(72) Inventors: Mark McEwen, Clinton, OH (US); Jon Misner, Hartville, OH (US); Jacob Walters, Medina, OH (US); Adam Karl Nesbitt, Akron, OH (US); Jon Stuckey, Louisville, OH (US); Robert Asper, Wadsworth, OH (US)

(21) Appl. No.: 14/182,386

(22) Filed: Feb. 18, 2014

Related U.S. Application Data
(60) Provisional application No. 61/846,591, filed on Jul. 15, 2013.

(51) Int. Cl. B60C 11/00; B29C 43/58; B29C 43/20; B60C 13/00

(52) U.S. Cl. CPC B60C 11/0008; B60C 13/001; B29C 43/58; B29C 43/20
USPC 152/525; 152/151; 264/40.4; 526/72

(57) ABSTRACT

Various embodiments of a compression molded green rubber component, and methods for manufacturing the same, are disclosed.

### CROSS-REFERENCE TO RELATED APPLICATIONS

This application claims priority from U.S. Provisional Patent Application No. 61/846,591, filed on Jul. 15, 2013, which is incorporated by reference herein in its entirety.

### BACKGROUND

Rubber articles are often formed by vulcanizing “green” rubber components, which have been prepared prior to vulcanization. Many rubber articles are used in applications that result in wear of the rubber article. One such rubber article is a tire.

Many rubber articles are formed by the layering of various components, including green rubber components, which results in certain components forming the wear portions of the rubber article. Typically, specific components are oriented in the portion of the rubber article that will experience wear. Such specific components may comprise properties desirable for performance or aesthetic purposes, including specific compounds or colors.

In the case of the tire, wear components may include the tread and sidewall portions of the tire. As the tread and/or sidewall portions of the tire wear, the original wear components disappear. The result is the exposure of other components of the tire to wear, which may be disadvantageous.

What is needed is a rubber article and methods for manufacturing rubber article that allow the mixture of various components at various points in the article wear portions.

### SUMMARY

In one embodiment, a tire is provided, the tire comprising: a sidewall portion, wherein the sidewall portion comprises a plurality of rubber stock components cut into component pieces, and wherein at least two of the component pieces comprise at least one of a different color and a different compound.

In another embodiment, a tire is provided, the tire comprising: a tread portion, wherein the tread portion comprises a plurality of rubber stock components cut into component pieces, and wherein at least two of the component pieces comprise at least one of a different color and a different compound.

In one embodiment, a molded component is provided, the molded component comprising: a plurality of rubber stock components cut into component pieces; wherein at least two of the component pieces comprise at least one of a different color and a different compound.

In one embodiment, a method for making a molded component is provided, the method comprising: at least one of extruding, milling, and calendaring at least two individual colored rubber stock components; cutting the at least two individual colored rubber stock components into smaller component pieces; mixing the component pieces to obtain a mixture of colors of the component pieces; weighing the component pieces to obtain an appropriate volume for molding a molded component; and placing the appropriate volume of the mixture of component pieces into a compression mold and compression molding the mixture of component pieces to create the molded component.

In another embodiment, a method for making a molded component is provided, the method comprising: at least one of extruding, milling, and calendaring at least two individual rubber stock components comprising different compounds; cutting the at least two individual rubber stock components comprising different compounds into smaller component pieces; mixing the component pieces to obtain a mixture of the component pieces comprising different compounds; weighing the component pieces to obtain an appropriate volume for molding a molded component; and placing the appropriate volume of the mixture of component pieces into a compression mold and compression molding the mixture of component pieces to create the molded component.

### BRIEF DESCRIPTION OF THE DRAWINGS

The accompanying figures, which are incorporated in and constitute a part of the specification, illustrate various example apparatuses and methods, and are used merely to illustrate various example embodiments. In the figures, like elements bear like reference numerals.

FIG. 1 illustrates an example tire comprising compression molded green rubber components.

FIG. 2 illustrates an example embodiment of rubber stock components and component pieces.

FIG. 3 illustrates an example embodiment of component pieces.

FIG. 4 illustrates an example embodiment of component pieces arranged in a compression mold.

FIG. 5 illustrates an example embodiment of molded components.

FIG. 6 illustrates an example embodiment of molded components.

FIG. 7A illustrates an example embodiment of component pieces.

FIG. 7B illustrates an example embodiment of a molded component.

FIG. 8A illustrates an example embodiment of component pieces.

FIG. 8B illustrates an example embodiment of a molded component.

FIG. 9A illustrates an example embodiment of component pieces.

FIG. 9B illustrates an example embodiment of a molded component.

FIG. 10A illustrates an example embodiment of component pieces.

FIG. 10B illustrates an example embodiment of a molded component.

FIG. 11 illustrates an example method of manufacturing molded rubber components.

FIG. 12 illustrates an example method of manufacturing molded rubber components.

### DETAILED DESCRIPTION

Rubber articles, such as tires, are often comprised of a plurality of layers of green rubber components. The green rubber components, such as the tread and sidewall components, may be prepared in sheet form and applied to a tire building machine in such form. Such sheets may be prepared through a variety of methods, including extruding, milling, and calendaring.

The use of tread and/or sidewall components in sheet form may include certain limitations. For example, one may desire to place a more wear-resistant compound in the outer surfaces of the tread and/or sidewall components to minimize wear and increase the life of the tire. However, application of a sheet of wear-resistant compound results in the tire losing its wear resistance following the wearing away of the thickness of the wear-resistant compound.

In one embodiment, one may desire to apply a camouflage pattern to a tire. One means of achieving this pattern is through surface coloring. One such example of surface coloring includes applying colored patches to the surface of a tire and thereafter vulcanizing the tire. As noted above, this treatment has drawbacks, including the loss of the color once the thin patch material wears off the tire.

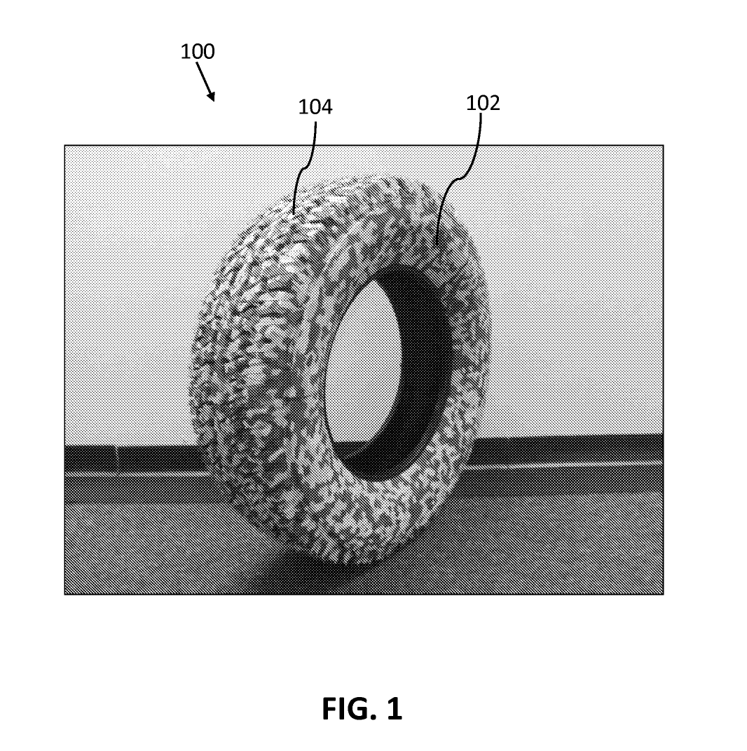

FIG. 1 illustrates an example tire 100 comprising compression molded green rubber components. Tire 100 comprises a sidewall portion 102 and a tread portion 104.

In one embodiment, tire 100 includes a camouflage pattern. In one embodiment, at least one of sidewall portion 102 and tread portion 104 comprise a camouflage pattern. In another embodiment, at least one of sidewall portion 102 and tread portion 104 comprise any color pattern and are not limited specifically to camouflage patterns. In one embodiment, at least one of sidewall portion 102 and tread portion 104 comprise any randomized color pattern comprising at least two colors.

In one embodiment, tire 100, including sidewall portion 102 and tread portion 104 comprise a rubber. In one embodiment, sidewall portion 102 and tread portion 104 comprise separate compounds. In one embodiment, sidewall portion 102 and tread portion 104 are formed independently of one another and the rest of the components of tire 100.

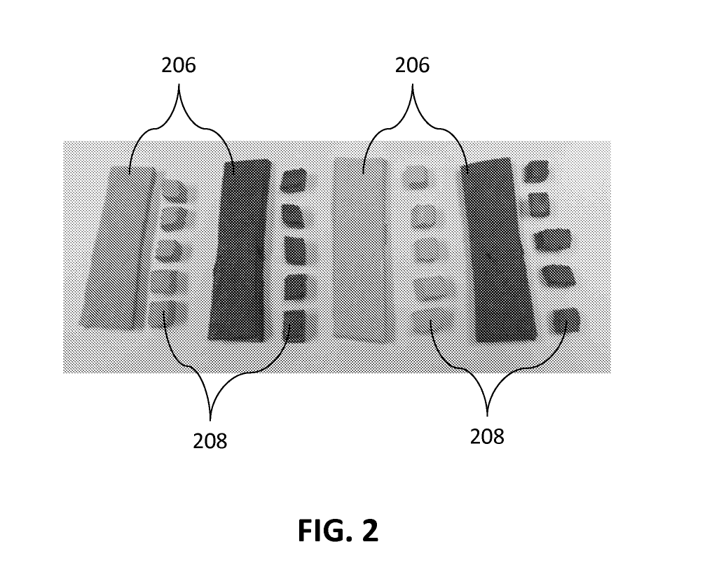

FIG. 2 illustrates an example embodiment of rubber stock components 206 and component pieces 208.

In one embodiment, rubber stock components 206 comprise colored rubber stock material. Rubber stock components 206 may comprise uncured “green” rubber. In another embodiment, rubber stock components 206 comprise a variety of separate colored rubber stock materials. In another embodiment, rubber stock components 206 comprise a colorant or dye configured to give rubber stock components 206 a specific desired color.

Rubber stock components 206 may be formed of any of a variety of methods, including through extrusion, milling, and calendaring. In one embodiment, rubber stock components 206 are extruded to a desired thickness. Rubber stock components 206 may be cut into a plurality of component pieces 208. Each of component pieces 208 may comprise all the same characteristics of its parent rubber stock component 206, with the exception of its size and shape. In one embodiment, rubber stock components 206 may be formed into any of thin sheets, thick sheets, blocks, or ribbon, as is desired by a user.

Each of rubber stuck components 206 may be cut into smaller component pieces 208. In one embodiment, at least one rubber stock component 206 is cut into different sized component pieces 208 as compared to each other rubber stock component 206. In another embodiment, each rubber stock component 206 is cut into substantially similarly sized component pieces 208.

Component pieces 208 may comprise uncured “green” rubber. Component pieces 208 may be formed in any of a variety of shapes, including regular and irregular shapes. In one embodiment, component pieces 208 are formed into substantially cube-like shapes. In one embodiment, component pieces 208 are formed into substantially cube-like shapes about 0.25 in. along each side. In another embodiment, component pieces 208 are formed into substantially thin sheet shapes. In another embodiment, component pieces 208 are formed into shapes that are similar to camouflage shapes. In another embodiment, component pieces 208 are formed into random shapes.

In one embodiment, rubber stock components 206 comprise rubber stock material comprising at least two different compounds. In one embodiment, rubber stock components 206 each comprise different rubber compounds. In another embodiment, rubber stock components 206 comprise components having the same color, but different compounds. In another embodiment, rubber stock component 206 comprise components having at least two colors, and at least two different compounds. In one embodiment, each rubber component 206 is cut into smaller component pieces 208, and each of component pieces 208 comprises the same compound as its parent rubber component 206. In one embodiment, rubber stock components 206 and component pieces 208 comprise any of a variety of possible compounds used in rubber articles, such as tires, including for example a winter compound, a low rolling resistance compound, a high wear life compound, and the like.

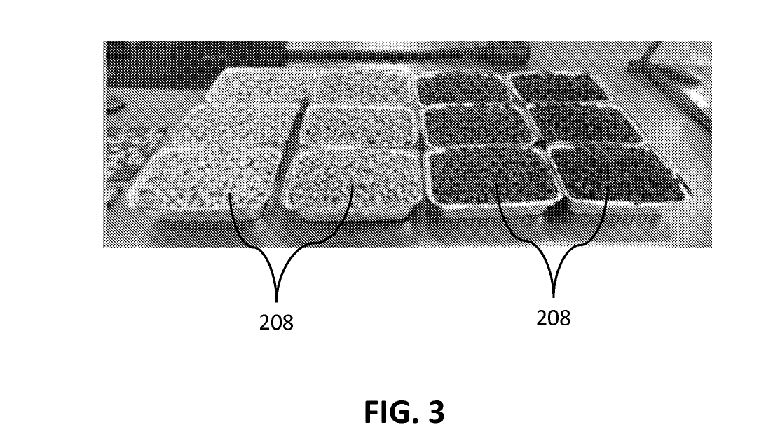

FIG. 3 illustrates an example embodiment of component pieces 208. In one embodiment, component pieces 208 may be collected and separated by color. In another embodiment, component pieces 208 may be collected and separated by compound. In another embodiment, component pieces 208 may be collected and separated by color and compound.

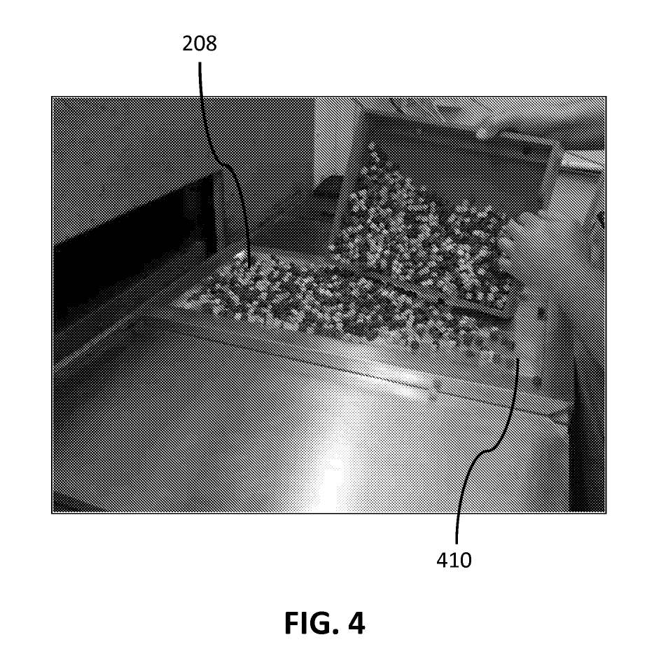

FIG. 4 illustrates an example embodiment of component pieces 208 arranged in a compression mold 410.

Various colors, compounds, or both of component pieces 208 may be mixed together to form a randomized mixture of component pieces 208. In one embodiment, component pieces 208 are weighed to obtain an appropriate volume of component pieces 208 for placement in compression mold 410 (where density of component pieces 208 is known).

In one embodiment, different proportions of colors are desired, and accordingly, different weights and volumes of differently colored component pieces 208 are included in the randomized mixture. In another embodiment, the same proportions of colors are desired, and accordingly, the same weights and volumes of differently colored component pieces 208 are included in the randomized mixture.

In one embodiment, different proportions of compounds are desired, and accordingly, different weights and volumes of differently compounded component pieces 208 are included in the randomized mixture. In another embodiment, the same proportions of compounds are desired, and accordingly, the same weights and volumes of differently compounded component pieces 208 are included in the randomized mixture.

Compression mold 410 may comprise a substantially flat mold. In one embodiment, compression mold 410 comprises a flat mold with a contour of the desired molded component.

In one embodiment, compression mold 410 comprises a length and width appropriate to allow an entire sidewall component to be molded within compression mold 410. In another embodiment, compression mold 410 comprises a length and width appropriate to allow a portion of a sidewall component to be molded within compression mold 410. In another embodiment, compression mold 410 comprises a length and width appropriate to allow an entire tread component to be molded within compression mold 410. In another embodiment, compression mold 410 comprises a length and width appropriate to allow a portion of a tread component to be molded within compression mold 410. In one embodiment, compression mold 410 comprises a length of at least about 20 in.

In one embodiment, compression mold 410 comprises a thickness appropriate to mold at least a portion of a sidewall component. In another embodiment, compression mold 410 comprises a thickness appropriate to mold an entire thickness of a sidewall component. In another embodiment, compression mold 410 comprises a thickness appropriate to mold at least a portion of a tread component. In another embodiment, compression mold 410 comprises a thickness appropriate to mold an entire thickness of a tread component.

In one embodiment, compression mold 410 is configured to compress a plurality of component pieces 208. In another embodiment, compression mold 410 is configured to compress a randomized mixture of component pieces 208.

In one embodiment, compression mold 410 is configured to compress component pieces 208 in the presence of a heat that is enough to allow component pieces 208 to change shape, but not enough to vulcanize component pieces 208.

In one embodiment, compression mold 410 is used to apply about 75 tons of force to component pieces 208. In another embodiment, compression mold 410 is used to apply between about 50 tons and about 100 tons of force to component pieces 208. In another embodiment, compression mold 410 is used to apply any amount of force to component pieces 208 that is appropriate to form a molded component.

In one embodiment, compression mold 410 applies heat to component pieces 208 at about 90° C. In another embodiment, compression mold 410 applies heat to component pieces 208 at between about 60° C. and about 120° C. In another embodiment, compression mold 410 is used to apply any amount of heat to component pieces 208 that is appropriate to form a molded component without actually vulcanizing the component.

In one embodiment, compression mold is used to apply force upon component pieces 208 for about 15 minutes. In another embodiment, compression mold is used to apply force upon component pieces 208 for between about 10 minutes and about 20 minutes. In another embodiment, compression mold 410 is used to apply force upon component pieces 208 for any amount of time that is appropriate to form a molded component without actually vulcanizing the component.

A typical vulcanization time and temperature for a passenger tire may be about 10 minutes at about 170° C.

In one embodiment, compression mold 410 may comprise a tread pattern, which will be applied to a molded component molded in compression mold 410. In one embodiment, the molded component is a tread component, and compression mold 410 is configured to impart a tread pattern upon the tread component. The tread component may be used on any of a variety of tire types, including agricultural tires, off-the-road tires, and the like. These tires may include large tread bars and may benefit from at least partial molding of the tread component before application to the rest of the green tire at the building machine.

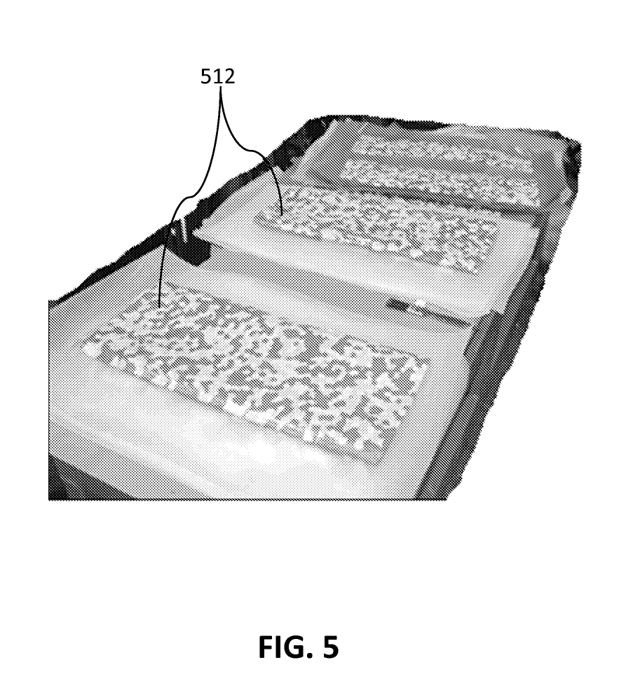

FIG. 5 illustrates an example embodiment of molded components 512. Molded component 512 may comprise at least one of a sidewall component and a tread component. Molded component 512 may comprise a substantially rectangular shape. In one embodiment, molded component 512 is contoured.

As illustrated, molded component 512 may comprise a camouflage pattern. In another embodiment, molded component 512 is comprised of a plurality of component pieces having different compounds, and molded component 512 comprises various compounds.

Molded component 512 comprises random colors and/or compounds through its thickness. Accordingly, when molded component 512 wears, it may continue to exhibit random colors and/or compounds at its surface. In one embodiment, molded component 512 comprises a tread component or a sidewall component, and maintains its random colors and/or compounds on its wear surface as the tread component or sidewall component wears.

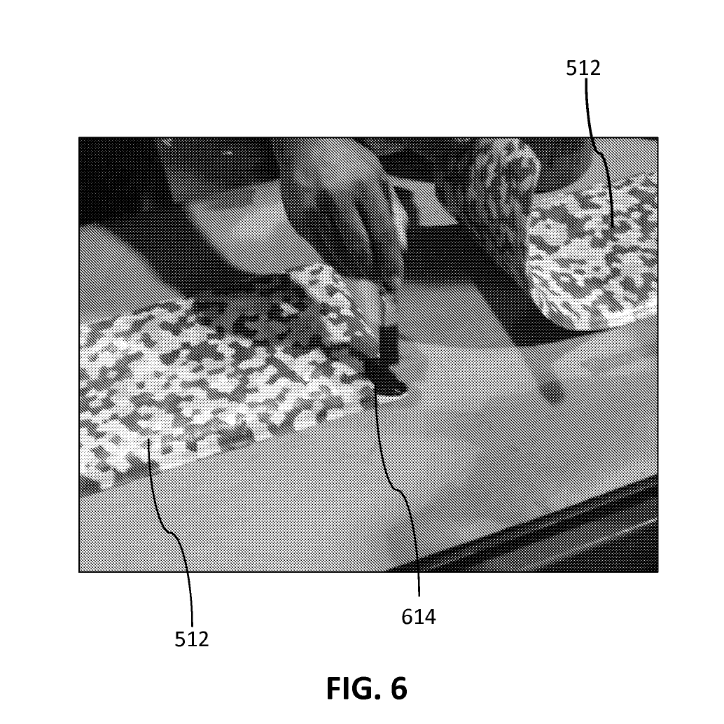

FIG. 6 illustrates an example embodiment of molded components 512. In one embodiment, molded components 512 are not of a length long enough to serve as an entire tread component or sidewall component. Accordingly, molded components 512 may be beveled and connected using a cement 614. Cement 614 may substantially bond molded components 512 to one another, or other tire components. In one embodiment, molded components 512 comprise sufficient tackiness to adhere to one another without cement 614.

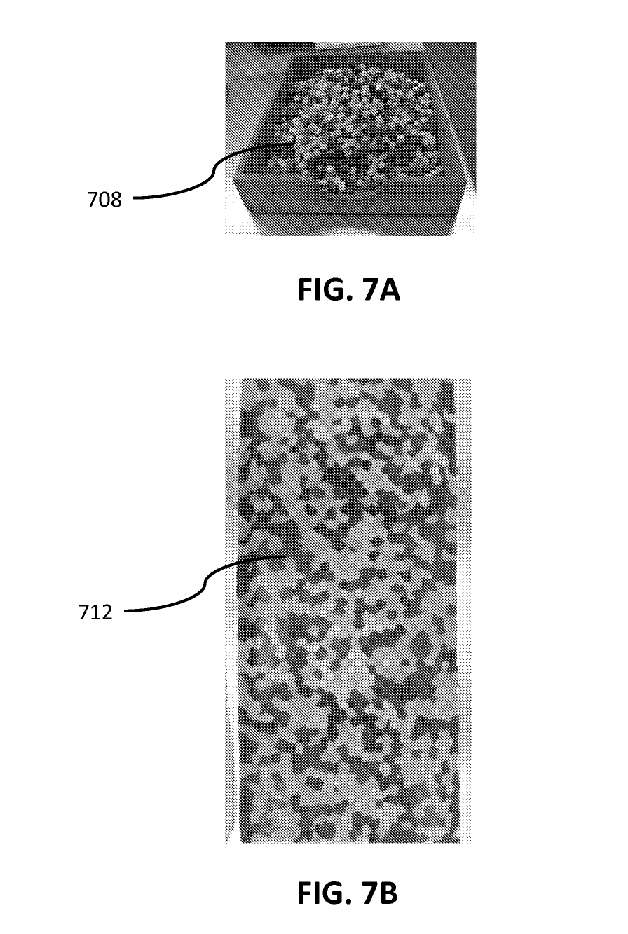

FIG. 7A illustrates an example embodiment of component pieces 708. Component pieces 708 may be substantially cube-like.

FIG. 7B illustrates an example embodiment of a molded component 712 illustrating a potential pattern made using cube-like component pieces 708.

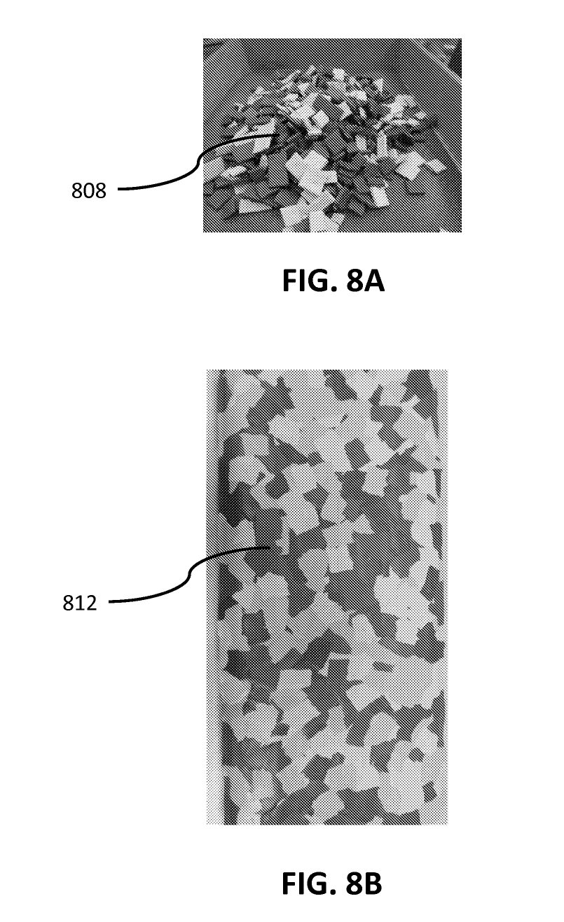

FIG. 8A illustrates an example embodiment of component pieces 808. Component pieces 808 may be substantially thin pieces of material cut into substantially square shapes.

FIG. 8B illustrates an example embodiment of a molded component 812 illustrating a potential pattern made using square component pieces 808.

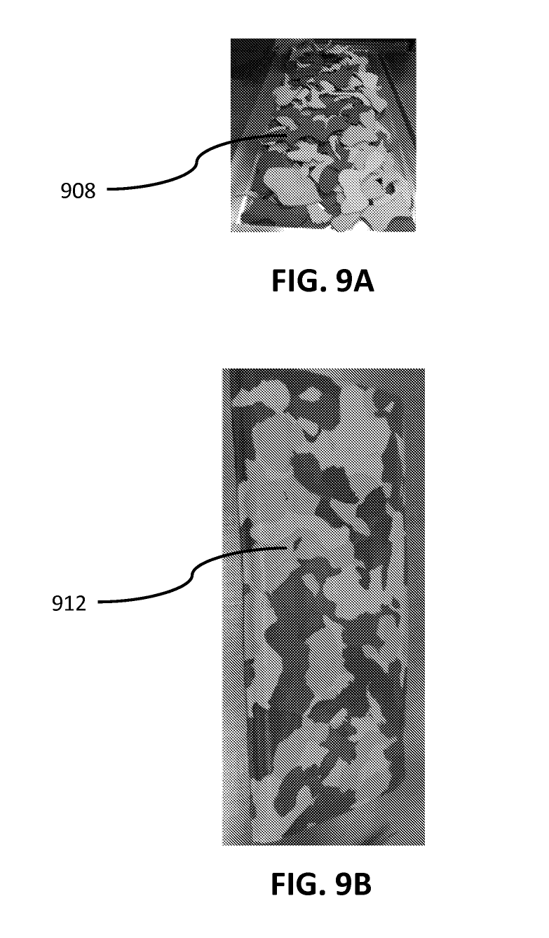

FIG. 9A illustrates an example embodiment of component pieces 908. Component pieces 908 may be substantially thin pieces of material cut into substantially random “camouflage” shapes.

FIG. 9B illustrates an example embodiment of a molded component 912 illustrating a potential pattern made using camouflage-shaped component pieces 908.

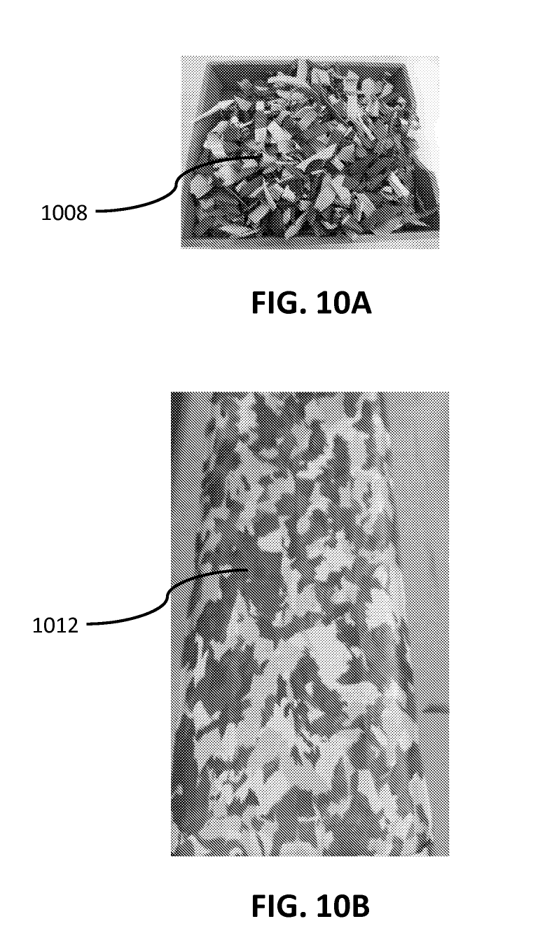

FIG. 10A illustrates an example embodiment of component pieces 1008. Component pieces 1008 may be substantially random pieces of material.

FIG. 10B illustrates an example embodiment of a molded component 1012 illustrating a potential pattern made using random component pieces 1008.

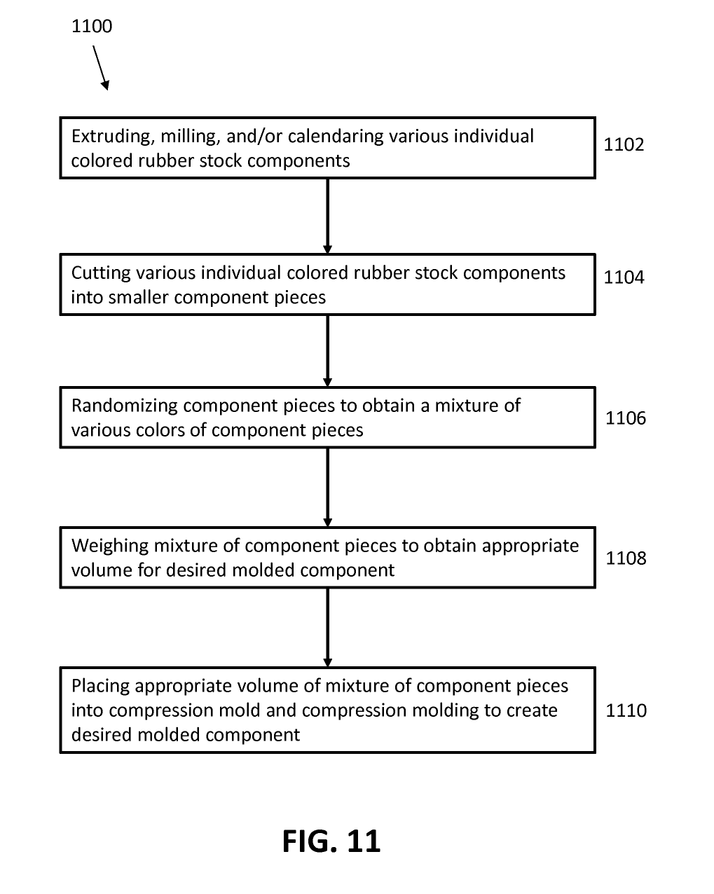

FIG. 11 illustrates an example method 1100 of manufacturing molded rubber components. Method 1100 comprises the steps of extruding, milling, and/or calendaring various individual colored rubber stock components (step 1102). The various individual colored rubber stock components are cut into smaller component pieces (step 1104). The component pieces are randomized to obtain a mixture of various colors of component pieces (step 1106). In order to obtain the appropriate volume of component pieces to be used to mold a desired molded component, the mixture of component pieces is weighed (step 1108). In one embodiment, the component pieces may be weighed before mixing, and specific amounts of each component piece may be added to the mixture of component pieces. The appropriate volume of the mixture of component pieces is placed into a compression mold, and molded to create a desired molded component (step 1110).

In one embodiment, method 1100 further comprises a step of adhering or splicing at least two molded components together to form a larger molded component. The molded components may be used to prepare tire tread components, tire sidewall components, or any other tire component. In another embodiment, method 1100 further comprises placement of the molded component onto a tire carcass and/or a tire building machine and using it to build a tire.

In one embodiment, step 1110 further comprises at least partially molding a tire tread pattern into the molded component, before application of the molded component to the rest of the green tire at the tire building machine.

Method 1100 may be used to mold any of a variety of rubber articles, including tires, pneumatic tires, non-pneumatic tires, and solid tires.

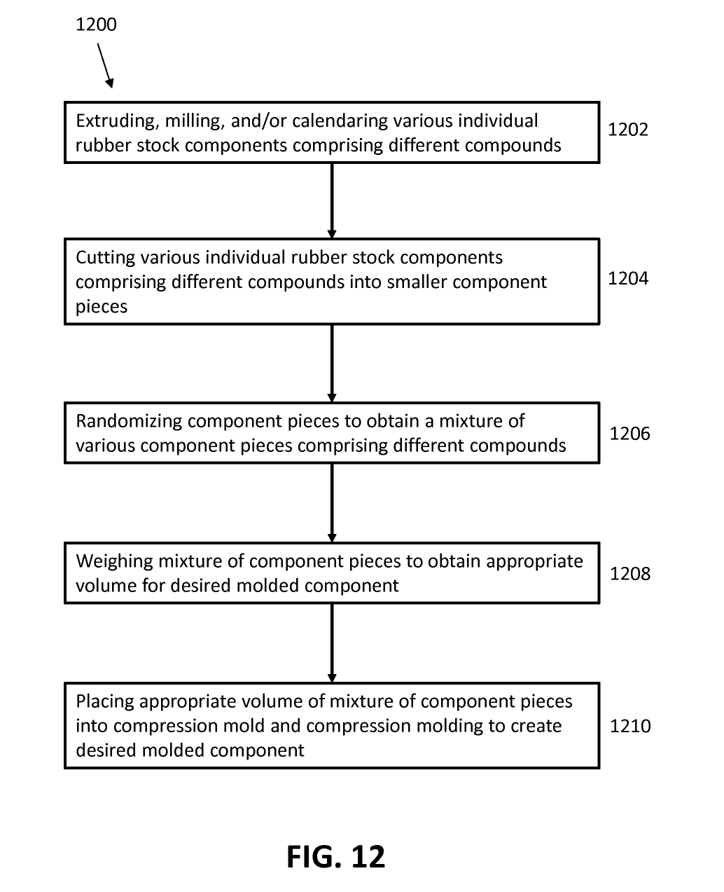

FIG. 12 illustrates an example method 1200 of manufacturing molded rubber components. Method 1200 comprises the steps of extruding, milling, and/or calendaring various individual rubber stock components comprising different compounds (step 1202). The various individual rubber stock components comprising different compounds are cut into smaller component pieces (step 1204). The component pieces are randomized to obtain a mixture of various component pieces comprising different compounds (step 1206). In order to obtain the appropriate volume of component pieces to be used to mold a desired molded component, the mixture of component pieces is weighed (step 1208). In one embodiment, the component pieces may be weighed before mixing, and specific amounts of each component piece may be added to the mixture of component pieces. The appropriate volume of the mixture of component pieces is placed into a compression mold, and molded to create a desired molded component (step 1210).

In one embodiment, method 1200 further comprises a step of adhering or splicing at least two molded components together to form a larger molded component. The molded components may be used to prepare tire tread components, tire sidewall components, or any other tire component. In another embodiment, method 1200 further comprises placement of the molded component onto a tire carcass and/or a tire building machine and using it to build a tire.

In one embodiment, step 1210 further comprises at least partially molding a tire tread pattern into the molded component, before application of the molded component to the rest of the green tire at the tire building machine.

Method 1200 may be used to mold any of a variety of rubber articles, including tires, pneumatic tires, non-pneumatic tires, and solid tires.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in tire manufacturing, which in one embodiment is ±0.25 inches. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A tire comprising:
a sidewall portion,
wherein the sidewall portion comprises a plurality of rubber stock components cut into component pieces, and
wherein at least two of the component pieces comprise at least one of a different color and a different compound.

2. The tire of claim 1, wherein the sidewall portion comprises a camouflage pattern.

3. The tire of claim 1, wherein the sidewall portion comprises a color pattern.

4. The tire of claim 1, further comprising a tread portion, and wherein the tread portion comprises a camouflage pattern.

5. The tire of claim 1, further comprising a tread portion, and wherein the tread portion comprises a color pattern.

6. The tire of claim 1, wherein the sidewall portion comprises at least two different compounds.

7. The tire of claim 1, further comprising a tread portion, and wherein the tread portion comprises at least two different compounds.

8. The tire of claim 1, wherein the sidewall portion is prepared by compression molding a sidewall component out of the component pieces without vulcanizing the sidewall component.

9. A tire, comprising:
a tread portion,
wherein the tread portion comprises a plurality of rubber stock components cut into component pieces, and
wherein at least two of the component pieces comprise at least one of a different color and a different compound.

10. The tire of claim 9 wherein the tread portion comprises a camouflage pattern.

11. The tire of claim 9, wherein the tread portion comprises a color pattern.

12. The tire of claim 9, further comprising a sidewall portion, and wherein the sidewall portion comprises a camouflage pattern.

13. The tire of claim 9, further comprising a sidewall portion, and wherein the sidewall portion comprises a color pattern.

14. The tire of claim 9, wherein the tread portion comprises at least two different compounds.

15. The tire of claim 9, further comprising a sidewall portion, and wherein the sidewall portion comprises at least two different compounds.

16. The tire of claim 9, wherein the tread portion is prepared by compression molding a tread component out of the component pieces without vulcanizing the tread component.

17. A molded component, comprising:
a plurality of rubber stock components cut into component pieces;
wherein at least two of the component pieces comprise at least one of a different color and a different compound.

18. The molded component of claim 17, wherein the molded component is prepared by compression molding the molded component out of the component pieces without vulcanizing the molded component.

19. The molded component of claim 17, wherein the molded component comprises a camouflage pattern.

20. The molded component of claim 17, wherein the molded component comprises a color pattern.

21. The molded component of claim 17, wherein the molded component comprises at least two different compounds.

22. The molded component of claim 17, wherein the molded component is at least one of a sidewall component and a tread component.

23. A method for making a molded component, comprising:
at least one of extruding, milling, and calendaring at least two individual colored rubber stock components;
cutting the at least two individual colored rubber stock components into smaller component pieces;
mixing the component pieces to obtain a mixture of colors of the component pieces;
weighing the component pieces to obtain an appropriate volume for molding a molded component; and
placing the appropriate volume of the mixture of component pieces into a compression mold and compression molding the mixture of component pieces to create the molded component.

24. The method for making a molded component of claim 23, wherein the component pieces are weighed prior to mixing the component pieces.

25. The method for making a molded component of claim 23, wherein the component pieces are weighed after mixing the component pieces.

26. The method for making a molded component of claim 23, further comprising splicing the molded component to another molded component.

27. The method for making a molded component of claim 23, wherein the molded component is at least one of a sidewall component and a tread component.

28. A method for making a molded component, comprising:
at least one of extruding, milling, and calendaring at least two individual rubber stock components comprising different compounds;
cutting the at least two individual rubber stock components comprising different compounds into smaller component pieces;
mixing the component pieces to obtain a mixture of the component pieces comprising different compounds;
weighing the component pieces to obtain an appropriate volume for molding a molded component; and
placing the appropriate volume of the mixture of component pieces into a compression mold and compression molding the mixture of component pieces to create the molded component.

29. The method for making a molded component of claim 28, wherein the component pieces are weighed prior to mixing the component pieces.

30. The method for making a molded component of claim 28, wherein the component pieces are weighed after mixing the component pieces.

31. The method for making a molded component of claim 28, further comprising splicing the molded component to another molded component.

32. The method for making a molded component of claim 28, wherein the molded component is at least one of a sidewall component and a tread component.
